(19) United States
(12) Patent Application Publication
(10) Pub. No.: US 2013/0120549 A1
(43) Pub. Date: May 16, 2013

(54) DISPLAY PROCESSING APPARATUS AND DISPLAY PROCESSING METHOD

(71) Applicants: Yoshiharu Momonoi, Kanagawa (JP); Kazuyasu Ohwaki, Tokyo (JP); Kenzo Isogawa, Tokyo (JP); Miki Yamada, Tokyo (JP)

(72) Inventors: Yoshiharu Momonoi, Kanagawa (JP); Kazuyasu Ohwaki, Tokyo (JP); Kenzo Isogawa, Tokyo (JP); Miki Yamada, Tokyo (JP)

(21) Appl. No.: 13/542,012

(22) Filed: Jul. 5, 2012

(30) Foreign Application Priority Data
Nov. 11, 2011 (JP) 2011-247107

(51) Int. Cl. H04N 7/18

(52) U.S. Cl. 348/78; 348/E07.085

(57) ABSTRACT

According to one embodiment, a display processing apparatus includes: a recognizes configured to recognize a viewer; an eyeball characteristic acquisition module configured to acquire an eyeball characteristic indicating visibility in eyes of each viewer recognized from eyeball characteristic information in which the eyeball characteristic of the viewer is recorded; a viewing distance acquisition module configured to acquire a viewing distance between the viewer recognized and a display configured to display an image; an image generator configured to generate a first image in which deterioration due to the eyeball characteristic of the viewer recognized when the viewer views the image displayed on the display at the viewing distance is compensated based on the viewing distance acquired and the eyeball characteristic of the viewer recognized; and a display controller configured to control the display to display the first image generated.

### CROSS-REFERENCE TO RELATED APPLICATIONS

This application is based upon and claims the benefit of priority from Japanese Patent Application No. 2011-247107, filed Nov. 11, 2011, the entire contents of which are incorporated herein by reference.

### FIELD

Embodiments described herein relate generally to a display processing apparatus and a display processing method.

### BACKGROUND

Conventionally known is a display apparatus, such as a liquid crystal display television, in which display processing for switching the peaking frequency of an image to be displayed is performed based on a viewing distance, thus eliminating the unconformity of visual-sense characteristic caused by changing viewing distances.

An eyeball characteristic, such as a modulation transfer function of eyes, indicating visibility in the eyes of a viewer varies among different individuals as visual acuity differs for each viewer. The above-mentioned conventional technique, however, does not take the eyeball characteristic that differs for each viewer into account, and fails to eliminate the unconformity of the visual-sense characteristic due to the eyeball characteristic that differs for each viewer. For example, even when a viewer having the standard visual acuity feels a certain image to be appropriate, the same image may look blurred to the eyes of a myopic viewer.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a digital television broadcasting receiver that is one example of a display processing apparatus according to an embodiment;

FIG. 2 is an exemplary block diagram illustrating a hardware configuration of the digital television broadcasting receiver in the embodiment;

FIG. 3 is an exemplary plan view illustrating the external appearance of a remote controller in the embodiment;

FIG. 4 is an exemplary flowchart illustrating one example of the operation of the digital television broadcasting receiver according to the inspection of eyeball characteristic of a viewer in the embodiment:

FIG. 5 is an exemplary conceptual view illustrating the inspection of the eyeball characteristic of the viewer in the embodiment;

FIG. 6 is an exemplary flowchart illustrating one example of the operation of the digital television broadcasting receiver for displaying images on a display in the embodiment; and

FIG. 7 is an exemplary conceptual view illustrating visibility of the viewer in the embodiment.

### DETAILED DESCRIPTION

In general, according to one embodiment, a display processing apparatus comprises: a recognizer configured to recognize a viewer; an eyeball characteristic acquisition module configured to acquire an eyeball characteristic indicating visibility in eyes of each viewer recognized from eyeball characteristic information in which the eyeball characteristic of the viewer is recorded; a viewing distance acquisition module configured to acquire a viewing distance between the viewer recognized and a display configured to display an image; an image generator configured to generate a first image in which deterioration due to the eyeball characteristic of the viewer recognized when the viewer views the image displayed on the display at the viewing distance is compensated based on the viewing distance acquired and the eyeball characteristic of the viewer recognized; and a display controller configured to control the display to display the first image generated.

Hereinafter, the display processing apparatus and the display processing method of an embodiment are specifically explained in reference to accompanying drawings. In the present embodiment, a general digital television broadcasting receiver is exemplified as the display processing apparatus. However, it is needless to say that the display processing apparatus may be a device such as a hard disk recorder or a set top box when the device is capable of displaying images on a display such as a liquid crystal display.

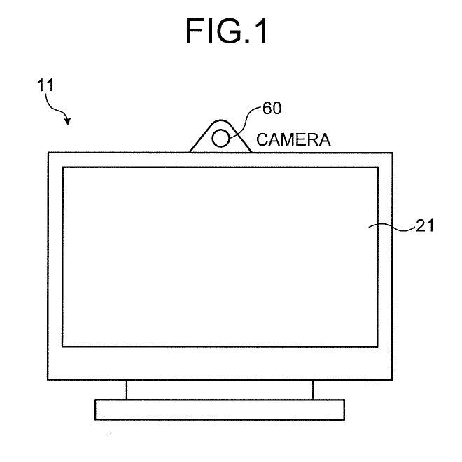

FIG. 1 is a front view of a digital television broadcasting receiver 11 that is one example of the display processing apparatus according to the embodiment. The digital television broadcasting receiver 11 (hereinafter, referred to as the “digital television 11”) may perform not only video display based on video signals for general planar vision (two-dimensional) display but also the video display based on the video signals for stereoscopic vision (three-dimensional) display.

As illustrated in FIG. 1, the digital television 11 comprises a display 21 that displays videos (images) based on the video signals for display and a camera 60 that picks up the image of a viewer viewing the display 21 on the front side thereof.

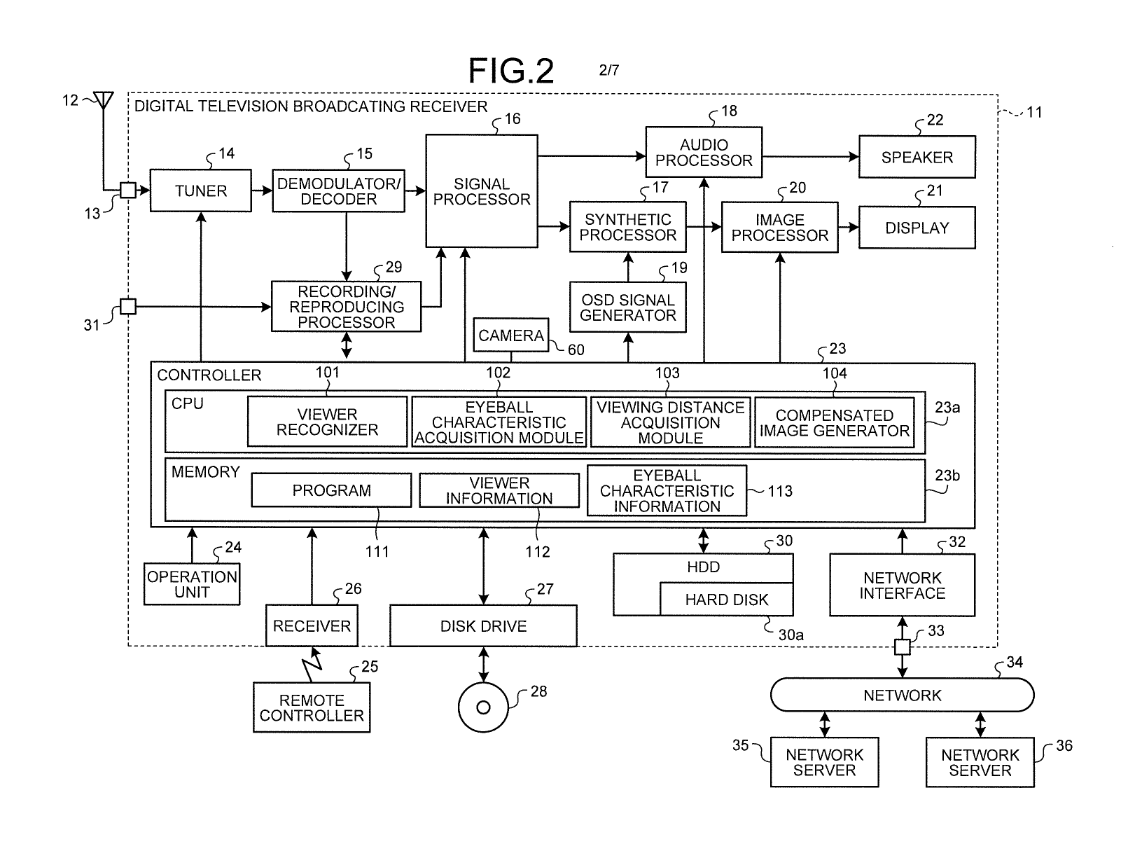

FIG. 2 is a block diagram illustrating a hardware configuration of the digital television 11. As illustrated in FIG. 2, the digital television 11 supplies digital television broadcasting signals received by an antenna 12 to a tuner 14 via an input terminal 13, thus making it possible to select a broadcasting signal of a desired channel.

The digital television 11 supplies the broadcasting signal selected by the tuner 14 to a demodulator/decoder 15 to restore the signal to a digital video signal, a digital audio signal, or the like, and outputs the signal to a signal processor 16 thereafter. The signal processor 16 applies predetermined digital signal processing to each of the digital video signal and the digital audio signal that are supplied from the demodulator/decoder 15.

The predetermined digital signal processing performed by the signal processor 16 also includes processing for converting the video signal for the general planar vision (two-dimensional) display to the video signal for the stereoscopic vision (three-dimensional) display and processing for converting the video signal for the stereoscopic vision display to the video signal for the planar vision display.

Furthermore, the signal processor 16 outputs the digital video signal to a synthetic processor 17 and outputs the digital audio signal to an audio processor 18. Out of these units, the synthetic processor 17 superimposes an on screen display (OSD) signal that is a video signal for superimposition such as a caption, a graphical user interface (GUI), or an OSD generated by an OSD signal generator 19 on the digital video signal supplied from the signal processor 16 and outputs the digital video signal.

The digital television 11 supplies the digital video signal output from the synthetic processor 17 to an image processor 20. The image processor 20 converts, under the control of a controller 23, the digital video signal input to an analog video signal of a format displayable on the subsequent-stage display 21 having a flat-type liquid crystal display panel or the like, for example. The digital television 11 supplies the analog video signal output from the image processor 20 to the display 21 so as to perform video display.

The audio processor 18 converts the digital audio signal input to the analog audio signal of a format reproducible by a subsequent-stage speaker 22. Furthermore, the analog audio signal output from the audio processor 18 is supplied to the speaker 22 so as to perform audio reproduction.

The digital television 11 intensively controls all operations thereof including the above-mentioned various receiving operations using the controller 23. The controller 23 incorporates a central processor (CPU) 23a and controls, in response to operation information from an operation unit 24 placed on the body of the digital television 11 or operation information transmitted from a remote controller 25 and received in a receiver 26, each unit so as to reflect the contents of the operation information.

The controller 23 utilizes a memory 23b. The memory 23b mainly has a read only memory (ROM) storing therein a computer program 111 executed by the CPU 23a, a random access memory (RAM) for providing a work area to the CPU 23a, and a nonvolatile memory that stores therein various types of setting information such as viewer information 112 and eyeball characteristic information 113, control information, and the like. The CPU 23a loads the program 111 on the work area in the RAM to sequentially execute the program, thus providing functions as a viewer recognizer 101, an eyeball characteristic acquisition module 102, a viewing distance acquisition module 103, and a compensated image generator 104 (specifically explained later).

The viewer information 112 is information in which the viewer who utilizes the digital television 11 is registered in advance. To be more specific, the viewer information 112 is a data file in which a viewer's face image picked up by a camera 60, setting information of the viewer, and the like are recorded for each viewer ID that identifies the viewer.

In the eyeball characteristic information 113, the eyeball characteristic indicating visibility in the eyes of the viewer for each viewer registered in the viewer information 112 is recorded. To be more specific, the eyeball characteristic information 113 is a data file in which the viewer's eyeball characteristic to which the viewer ID is set is recorded for each viewer ID recorded in the viewer information 112.

The viewer's eyeball characteristic recorded in the eyeball characteristic information 113 indicates a numerical value into which the visibility of an image in the eyes of the viewer, that is, the blurring of the video image that is visually recognized by the viewer is converted. To be more specific, the viewer's eyeball characteristic means the spatial frequency characteristic of the eyes of the viewer for each viewer-to-display distance (distance to an object to be viewed, equivalent to the viewing distance) of the viewer, and corresponds to the optical transfer function in the eyeball. For example, when the eyeball characteristic of a viewer having the standard eyesight and the eyeball characteristic of a myopic viewer are compared with each other, the blurring of the video image visually recognized by the viewer having the standard eyesight is the substantially same as that of the video image visually recognized by the myopic viewer at a short viewing distance. On the other hand, the blurring of the video image visually recognized by the myopic viewer increases at a long viewing distance.

Furthermore, the controller 23 connects a disk drive 27. The disk drive 27 is, for example, capable of loading and unloading an optical disk 28 such as a digital versatile disk (DVD) and has a function to perform recording and reproducing operations of digital data on the optical disk 28 loaded.

The controller 23 controls and causes a recording/reproducing processor 29 to encode, based on the operation of the operation unit 24 or the remote controller 25 made by the viewer, the digital video signal and the digital audio signal that are obtained from the demodulator/decoder 15 and convert the encoded signals into the predetermined recording format. Thereafter, the controller 23 supplies the signals to the disk drive 27 and controls and causes the disk drive 27 to record the signals on the optical disk 28.

Furthermore, the controller 23 causes, based on the operation of the operation unit 24 or the remote controller 25 made by the viewer, the disk drive 27 to read out the digital video signal and the digital audio signal from the optical disk 28, and decodes the signals using the recording/reproducing processor 29. Thereafter, the controller 23 can supply the signals to the signal processor 16 for the video display and the audio reproduction in the subsequent stage.

The controller 23 connects a hard disk drive (HDD) 30. The controller 23 controls and causes the recording/reproducing processor 29 to encode, based on the operation of the operation unit 24 or the remote controller 25 made by the viewer, the digital video signal and the digital audio signal obtained from the demodulator/decoder 15 and convert the encoded signals into the predetermined recording format. Thereafter, the controller 23 supplies the signals to the HDD 30 and controls and causes the HDD 30 to record the signals on a hard disk 30a.

Furthermore, the controller 23 causes, based on the operation of the operation unit 24 or the remote controller 25 made by the viewer, the HDD 30 to read out the digital video signal and the digital audio signal from the hard disk 30a, and decodes the signals using the recording/reproducing processor 29. Thereafter, the controller 23 supplies the signals to the signal processor 16 for the video display and the audio reproduction in the subsequent stage.

In addition, the digital television 11 connects an input terminal 31. The input terminal 31 is used for directly inputting the digital video signal and the digital audio signal from the outside of the digital television 11. The digital video signal and the digital audio signal that are input via the input terminal 31 are transmitted, based on the control of the controller 23, to the recording/reproducing processor 29. Thereafter, the controller 23 supplies the signals to the signal processor 16 for the video display and the audio reproduction in the subsequent stage.

Furthermore, the digital video signal and the audio digital signal that are input via the input terminal 31 are transmitted, based on the control of the controller 23, to the recording/reproducing processor 29. Thereafter, the controller 23 controls and causes the disk drive 27 to perform recording and reproduction on the optical disk 28, and controls and causes the HDD 30 to perform the recording and the reproduction on the hard disk 30a.

The controller 23 also controls, based on the operation of the operation unit 24 or the remote controller 25 made by the viewer, the disk drive 27 and the HDD 30 so that the digital video signal and the digital audio signal that are recorded on the optical disk 28 are transmitted to the HDD 30 to record the signals on the hard disk 30a, and the digital video signal and the digital audio signal that are recorded on the hard disk 30a are transmitted to the disk drive 27 to record the signals on the optical disk 28.

Furthermore, the controller 23 connects a network interface 32. The network interface 32 is connected to an outside network 34 via an input/output terminal 33. The network 34 connects a plurality of network servers 35 and 36 (two servers illustrated in the drawing) for providing various services using a communication function via the network 34. Due to such a constitution, the controller 23 accesses to the desired network server 35 or 36 via the network interface 32, the input/output terminal 33, and the network 34 to perform information communications, thus making it possible to utilize the services provided by the network server 35 or 36.

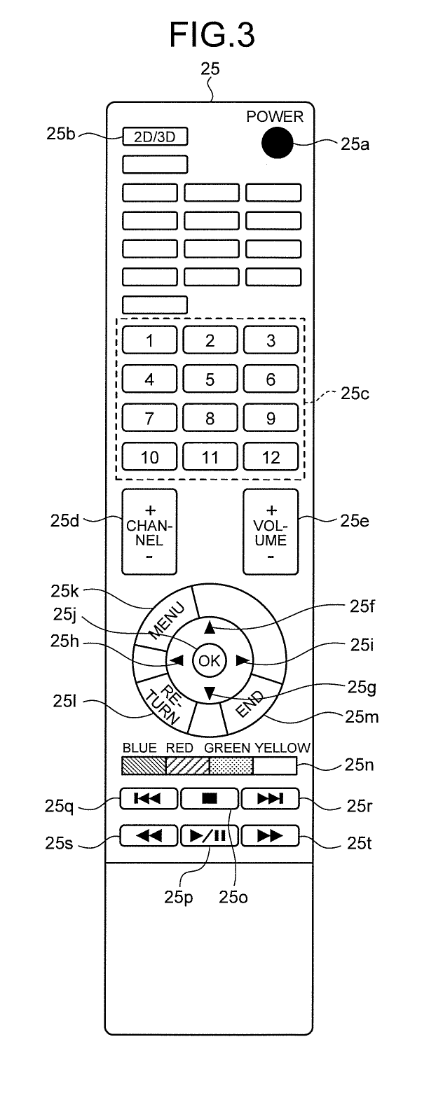

The remote controller 25 is explained in detail. FIG. 3 is a plan view illustrating the external appearance of the remote controller 25. As illustrated in FIG. 3, the remote controller 25 mainly comprises a power key 25a, a 2D/3D switching key 25b, a numerical keypad 25c, a channel up (+)/down (−) key 25d, a volume control key 25e, a cursor up (▴) key 25f, a cursor down (▾) key 25g, a cursor left ( [symbol] ) key 25h, a cursor right ( [symbol] ) key 25i, a determination key 25j, a menu key 25k, a return key 25l, an end key 25m, and four colored (blue, red, green, and yellow) keys 25n.

Furthermore, the remote controller 25 comprises a reproduction stop key 25o, a reproduction/pause key 25p, a backward-direction skip key 25q, a forward-direction skip key 25r, a fast-rewind key 25s, a fast-forward key 25t, and the like.

That is, the digital television 11 is capable of performing the reproduction, stopping, and pausing operations of the video and audio information or the like acquired from the disk drive 27 or the HDD 30 by the operation of the reproduction stop key 25o or the reproduction/pause key 25p of the remote controller 25. Furthermore, the digital television 11 is capable of skipping, by the operation of the backward-direction skip key 25q or the forward-direction skip key 25r of the remote controller 25, the video and audio information or the like being reproduced by the disk drive 27 or the HDD 30 at fixed intervals in a backward direction or a forward direction relative to the direction of reproducing the video and audio information; that is, the digital television 11 is capable of performing a so-called forward-direction skip operation or backward-direction skip operation. Furthermore, the digital television 11 is capable of continuously reproducing, by the operation of the fast-rewind key 25s or the fast-forward key 25t of the remote controller 25, the video and audio information or the like being reproduced by the disk drive 27 or the HDD 30 at high speed in the backward direction or the forward direction relative to the direction of reproducing the video and audio information; that is, the digital television 11 is capable of performing a so-called fast-rewind reproducing operation or fast-forward reproducing operation. In addition, the digital television 11 receives, for example, the instruction from the viewer when the viewer inspects the eyeball characteristic by the operation of the cursor up (▴) key 25f, the cursor down (▾) key 25g, the cursor left ( [symbol] ) key 25h, the cursor right ( [symbol] ) key 25i, the determination key 25j, or the like of the remote controller 25.

The explanation is made again in reference to FIG. 2. The viewer recognizer 101, the eyeball characteristic acquisition module 102, the viewing distance acquisition module 103, and a compensated image generator 104 that are realized by the CPU 23a are explained in detail.

The viewer recognizer 101 recognizes or authenticates the viewer who utilizes the digital television 11. To be more specific, the viewer recognizer 101 recognizes, based on the viewer ID input by the operation of the operation unit 24, the remote controller 25, or the like or the viewer's facial image picked up by the camera 60, the viewer having information that matches with the information recorded in the viewer information 112 as a viewer utilizing the digital television 11. In this manner, face recognition is performed by comparing the viewer's facial image picked up by the camera 60 with facial images recorded in the viewer information 112, thus making it easier to perform the recognition of the viewer compared with the case where the viewer ID is input.

The eyeball characteristic acquisition module 102 acquires the eyeball characteristic of the viewer recognized by the viewer recognizer 101 for each viewer from the eyeball characteristic information 113 in which the eyeball characteristic indicating visibility in the eyes of the viewer is recorded. Furthermore, the eyeball characteristic acquisition module 102 controls the display 21 to display an image for measuring the spatial frequency characteristic of the eyes of the viewer for each viewing distance at the viewing distance and hence, the eyeball characteristic acquisition module 102 may acquire the eyeball characteristic of the viewer based on the operation received via the remote controller 25 operated by the viewer in response to the display of the image.

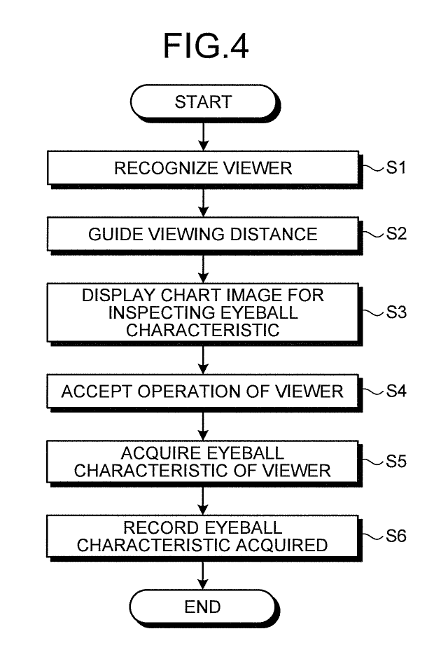

FIG. 4 is a flowchart illustrating one example of the operation of the digital television 11 according to the inspection of the eyeball characteristic of the viewer. As illustrated in FIG. 4, the viewer recognizer 101 recognizes the viewer (S1) and, thereafter, the eyeball characteristic acquisition module 102 causes the display 21 to display the viewing distance for the inspection to guide the viewing distance for inspection in order to make the viewer move toward a position at the viewing distance necessary for the inspection (S2).

Next, the eyeball characteristic acquisition module 102 causes the display 21 to display a chart image for inspecting the eyeball characteristic (S3), and receives the operation of the remote controller 25 made by the viewer (S4). To be more specific, at S3, the eyeball characteristic acquisition module 102 causes the display 21 to display the chart image of vertical stripes or horizontal stripes exhibiting the predetermined luminance value at fixed intervals and, at S4, the eyeball characteristic acquisition module 102 receives the operation of whether or not the chart image can be seen from the remote controller 25.

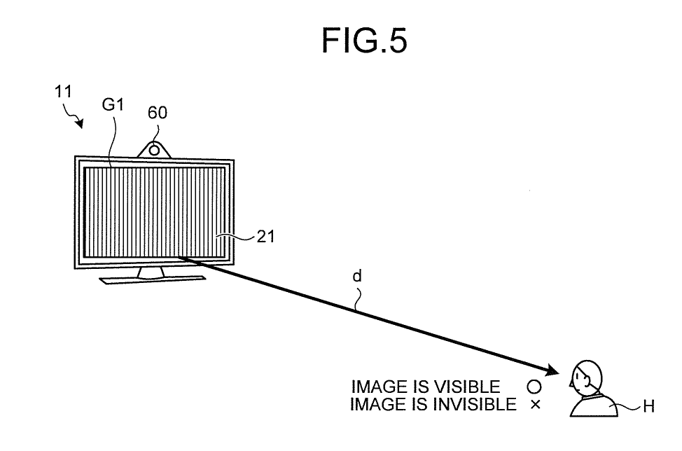

FIG. 5 is a conceptual view illustrating the inspection of the eyeball characteristic of the viewer. As illustrated in FIG. 5, the chart image G1 (vertically striped pattern illustrated in the drawing) is displayed on the display 21, and the eyeball characteristic acquisition module 102 receives the operation of “visible” or “invisible” from the viewer H away from the display 21 by the viewing distance d.

The eyeball characteristic acquisition module 102 repeatedly performs S3 and S4 while sequentially changing the intervals and the luminance value of the vertical stripes or the horizontal stripes in the chart image, and determines the chart image of the vertical stripes or the horizontal stripes having the intervals and the luminance value that become impossible to be seen by the viewer. Hence, the eyeball characteristic acquisition module 102 acquires a two-dimensional spatial frequency characteristic of the eyes of the viewer, that is, the eyeball characteristic of the viewer (S5).

The eyeball characteristic acquisition module 102 performs the processes of S2 to S5 for each viewing distance (1.5 m, 2 m, 3 m, and 5 m, for example) for the inspection, and records the eyeball characteristic acquired for each viewing distance with the viewer ID of the viewer recognized in the eyeball characteristic information 113 (S6).

The explanation is made again in reference to FIG. 2. The viewing distance acquisition module 103 acquires the viewing distance between the viewer recognized by the viewer recognizer 101 and the display 21. To be more specific, the viewing distance acquisition module 103 calculates the viewing distance based on the operation of inputting the viewing distance made by the viewer via the remote controller 25 or the viewer's image picked up by the camera 60 to acquire the viewing distance. The calculation of the viewing distance based on the viewer's image picked up by the camera 60 is performed based on the ratio of the area of the viewer's image occupied in the image picked up or the comparison between the image of the remote controller 25 or the like having a predetermined length and the image of the viewer. In this manner, the viewing distance acquisition module 103 acquires the viewing distance based on the viewer's image picked up by the camera 60 thus easily acquiring the viewing distance without causing the viewer to perform complicated operations such as the operation of inputting the viewing distance.

The compensated image generator 104 generates, when the viewer recognized views the image displayed on the display 21 at the position away from the display 21 by the viewing distance of the viewer recognized, an image whose deterioration due to the eyeball characteristic of the viewer is compensated based on the viewing distance acquired by the viewing distance acquisition module 103 and the eyeball characteristic of the viewer recognized by the viewer recognizer 101. To be specific, the compensated image generator 104 controls the filter factor or the like of the image processing performed in the image processor 20 so as to generate the image whose deterioration due to the eyeball characteristic of the viewer is compensated by the image processing performed in the image processor 20, and causes the display 21 to display the image generated.

The image whose deterioration due to the eyeball characteristic of the viewer is compensated is explained as follows; that is, when the viewer views an image displayed on the display 21 at the position away from the display 21 by the viewing distance of the viewer, the image visually recognized by the viewer is calculated backward based on the spatial frequency characteristic of the eyes of the viewer, and thus, the actually displayed image is compensated for the spatial frequency characteristic for compensating the deterioration of the image recognized visually by the viewer. For example, when the viewer recognized is a myopic person, the viewer feels that the image is blurred even when the other viewer having the standard visual acuity feels that the image is appropriate at the position away from the display 21 by the viewing distance same as that of the myopic viewer. When the viewer is at the position away from the display 21 by the viewing distance at which the viewer feels that the image is blurred, the compensated image generator 104 generates, according to the spatial frequency characteristic of the eyes of the viewer, an image whose high frequency band is strongly enhanced for the myopic viewer. However, when the viewing distance is short, even the myopic viewer does not feel that the image is blurred. Hence, the compensated image generator 104 generates, according to the spatial frequency characteristic of the eyes of the viewer, an image whose high frequency band is slightly enhanced or not enhanced.

A backward calculation method is specifically explained. The following Expression (1) illustrates the relationship between a blurred image (i_{blurre}) formed on retinas of the viewer and an image (i_{display}) displayed on the display 21.

i_{blurre}=a*i_{display} (1)

The eyeball characteristic of the viewer means the spatial frequency characteristic of the eyes of the viewer and corresponds to the optical transfer function in the eyeball and hence, as illustrated in Expression (1), the image (i_{blurre}) recognized visually by the viewer and formed on the retinas of the viewer is expressed by superposition of the image (i_{display}) displayed on the display 21 and an impulse response (spatial frequency characteristic (a)).

This relationship is, as illustrated in Expression (2), expressed by multiplication in the Fourier space.

F{i_{blurre}}=F{a}·F{i_{display}} (2)

Accordingly, as illustrated in the following Expression (3), it is possible to calculate an image (i_{compensation}) in which the deterioration of the image recognized visually by the viewer is compensated from the image actually displayed by backward calculation.

i_{compensation}=F⁻¹{D{i_{display}}/F{a}} (3)

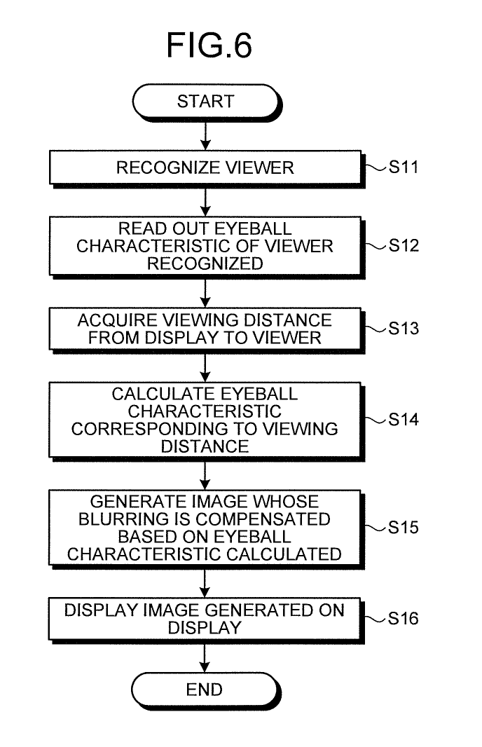

FIG. 6 is a flowchart illustrating one example of the operation of the digital television 11 for displaying images on the display 21. As illustrated in FIG. 6, the viewer recognizer 101 recognizes the viewer (S11) and, thereafter, the eyeball characteristic acquisition module 102 reads out and acquires the eyeball characteristic of the viewer recognized from the eyeball characteristic information 113 (S12).

Next, the viewing distance acquisition module 103 acquires the viewing distance from the display screen of the display 21 to the viewer (S13). Thereafter, the compensated image generator 104 calculates the eyeball characteristic corresponding to the viewing distance acquired (S14). To be specific, the compensated image generator 104 calculates, with respect to the eyeball characteristic for each viewing distance (1.5 m, 2 m, 3 m, 5 m, or the like, for example) of the viewer recognized, the value of the eyeball characteristic corresponding to the viewing distance acquired by linear approximations or the like.

Next, the compensated image generator 104 applies the calculated eyeball characteristic to the above-mentioned expression for backward calculation to generate the image whose blurring is compensated in the image processor 20 (S15). Thereafter, the digital television 11 causes the display 21 to display the image generated in the image processor 20 (S16).

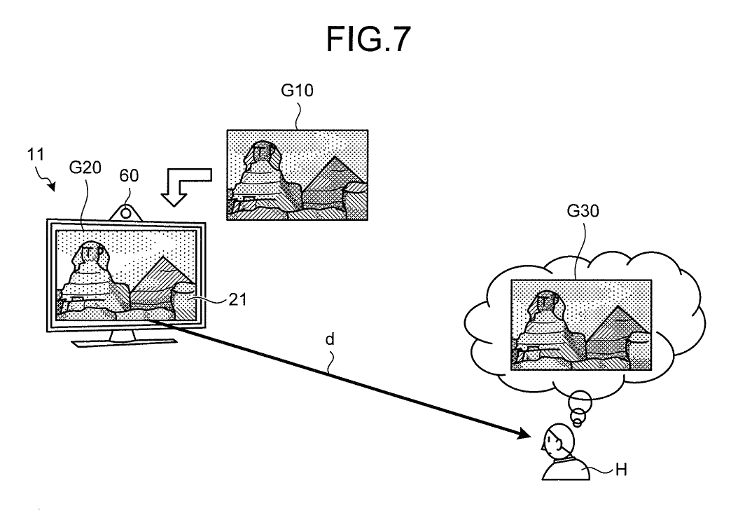

FIG. 7 is a conceptual view illustrating visibility of the viewer H. A source image G10 illustrated in FIG. 7 is an image input to the image processor 20; that is, an image received by the tuner 14, an image read out from the optical disk 28, an image provided by the network server 35 or 36, or the like. In the digital television 11, with respect to the source image G10, the image processing for compensating the above-mentioned blurring of the image is performed in the image processor 20. Accordingly, on the display 21, when the viewer H views the display 21 at the position away from the display 21 by the viewing distance d, a display image G20 whose deterioration due to the eyeball characteristic of the viewer H is compensated is displayed and hence, the viewer H can recognize a visual image G30 close to the source image G10. That is, in the digital television 11, even when the eyeball characteristic is different depending on the viewer H, it is possible to ensure consistency between the source image G10 and the visual image G30.

In the above-mentioned embodiment, exemplified is the case where one viewer is recognized and the image processing for compensating the blurring of the image is performed according to the eyeball characteristic of the recognized viewer. However, the viewer to be recognized is not limited to one viewer. For example, the viewer recognizer 101 may recognize a plurality of viewers.

When the viewer recognizer 101 recognizes the viewers, the compensated image generator 104 calculates an effect factor of the blurring-compensated image acquired by the above-mentioned expression for backward calculation for each viewer, and causes the image processor 20 to generate the totally optimized image whose effect factor for all of the viewers becomes maximum as an image whose blurring is compensated for all of the viewers. To be specific, for one viewer, the compensated image generator 104 calculates a numerical value indicative of a positive effect given by the blurring-compensated image acquired by the above-mentioned expression for backward calculation and a numerical value indicative of a negative effect on the other viewer when the image is displayed so as to calculate the effect factor for the viewer. Next, the effect factors for all viewers are calculated and, thereafter, the image having the largest effect factor is determined as the totally optimized image.

The program 111 executed in the digital television 11 of the present embodiment is provided in the form of the ROM or the like into which the program is integrated in advance. The program 111 executed in the digital television 11 of the present embodiment may be provided in the form of the storage medium capable of being read by the computer; that is, a CD-ROM, a flexible disk (FD), a CD-R, the digital versatile disk (DVD), or the like in which the program 111 is recorded in an installable or executable file.

The program 111 executed in the digital television 11 of the present embodiment may be stored on the computer connected to a network such as the Internet and provided by downloading via the network. In addition, the program 111 executed in the digital television 11 of the present embodiment may be provided or distributed via a network such as the Internet.

The program 111 executed in the digital television 11 of the present embodiment is constituted of modules including the above-mentioned respective modules (the viewer recognizer 101, the eyeball characteristic acquisition module 102, the viewing distance acquisition module 103, and the compensated image generator 104). As actual hardware, a CPU (processor) 23a reads out the program 111 from the ROM to execute the program 111, and thus the above-mentioned respective modules are loaded on a main memory and generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display processing apparatus comprising:
a recognizer configured to recognize a viewer;
an eyeball characteristic acquisition module configured to acquire an eyeball characteristic indicating visibility in eyes of each viewer recognized from eyeball characteristic information in which the eyeball characteristic of the viewer is recorded;
a viewing distance acquisition module configured to acquire a viewing distance between the viewer recognized and a display configured to display an image;
an image generator configured to generate a first image in which deterioration due to the eyeball characteristic of the viewer recognized when the viewer views the image displayed on the display at the viewing distance is compensated based on the viewing distance acquired and the eyeball characteristic of the viewer recognized; and
a display controller configured to control the display to display the first image generated.

2. The display processing apparatus of claim 1, wherein
the eyeball characteristic is a spatial frequency characteristic of the eyes of the viewer,
the spatial frequency characteristic of the eyes of the viewer for each viewing distance is recorded in the eyeball characteristic information, and
the image generator is configured to back calculate, based on the spatial frequency characteristic of the eyes of the viewer corresponding to the viewing distance acquired, an image visually recognized by the viewer from the image to be displayed on the display to generate the first image in which deterioration due to the eyeball characteristic of the viewer is compensated.

3. The display processing apparatus of claim 2, further comprising:
an operation module configured to receive the viewer's operation, wherein
the eyeball characteristic acquisition module is configured to control the display to display a second image for measuring the spatial frequency characteristic of the eyes of the viewer for each viewing distance at the viewing distance and acquire the eyeball characteristic of the viewer based on the operation received from the viewer in response to the display of the second image.

4. The display processing apparatus of claim 1, further comprising:
a camera configured to pick up an image of the viewer from the display, wherein
the viewing distance acquisition module is configured to acquire the viewing distance based on the image of the viewer picked up by the camera.

5. The display processing apparatus of claim 1, further comprising:
a camera configured to pick up an image of the viewer from the display, wherein
the recognizer is configured to recognize, based on a face image of the viewer picked up by the camera, each viewer in reference to viewer information in which a face image of the each viewer is recorded.

6. The display processing apparatus of claim 1, wherein the image generator is configured to generate, when a plurality of viewers are recognized by the recognizer, an image whose effect factor for compensating deterioration due to eyeball characteristic becomes maximum when calculation is performed for all of the viewers recognized.

7. A display processing method comprising:
recognizing a viewer;
acquiring an eyeball characteristic indicating visibility in eyes of each viewer recognized from eyeball characteristic information in which the eyeball characteristic of the viewer is recorded;
acquiring a viewing distance between the viewer recognized and a display on which an image is displayed;
generating a first image in which deterioration due to the eyeball characteristic of the viewer recognized when the viewer views the image displayed on the display at the viewing distance is compensated based on the viewing distance acquired and the eyeball characteristic of the viewer recognized; and
controlling the display to display the first image generated.
